(19) United States
(12) Patent Application Publication
(10) Pub. No.: US 2025/0058590 A1
(43) Pub. Date: Feb. 20, 2025

(54) HEAVY TRUCK TIRE TREAD WITH DECOUPLING SIPES IN THE SHOULDER AND SACRIFICIAL RIB

(71) Applicant: COMPAGNIE GENERALE DES ETABLISSEMENTS MICHELIN, Clermont-Ferrand (FR)

(72) Inventors: Benoit FOUCHER, Clermont-Ferrand (FR); Stefan VOSS, Greer, SC (US)

(21) Appl. No.: 18/724,344

(22) PCT Filed: Dec. 30, 2021
(86) PCT No.: PCT/US2021/065658

§ 371 Date: Jun. 26, 2024

(51) Int. Cl. B60C 11/12; B60C 11/02

(52) U.S. Cl. CPC B60C 11/1236; B60C 11/02; B60C 11/1204; B60C 2011/1213; B60C 2200/06

(57) ABSTRACT

A tread for a heavy truck tire is provided that has a shoulder rib (22) with a shoulder rib upper surface (24), and a sacrificial rib (26) with a sacrificial rib upper surface (28). The sacrificial rib (26) is located outboard from the shoulder rib (22) in the lateral direction and engages the shoulder rib (22) such that an interface is present at engagement of the sacrificial rib and the shoulder rib. The sacrificial rib upper surface (28) is located closer to the central axis in the radial direction than the shoulder rib upper surface (24) is located to the central axis in the radial direction. A plurality of decoupling sipes (32) in the shoulder rib (22) extend through the interface and into the sacrificial rib (26). The decoupling sipes (32) are spaced from one another in the circumferential direction such that immediately successive ones of the decoupling sipes (32) are not in engagement at the interface.

### FIELD OF THE INVENTION

The subject matter of the present invention relates to a truck tire with a sacrificial rib and decoupling sipes for improved irregular wear performance. More particularly, the present application involves a heavy truck tire tread with a series of decoupling sipes spaced from one another in the sacrificial and shoulder rib so that these ribs engage one another at the interface between immediately successive decoupling sipes.

### BACKGROUND OF THE INVENTION

Manufacturers of heavy commercial vehicle tires have made progress in developing tire architectures and tire materials that allow increase in the wear resistance of tire treads and the reduction of the rolling resistance of tires while at the same time improving their level of grip and resistance to road hazard. Irregular tread wear is a great concern for heavy commercial vehicle tires as it can progressively induce tire vibrations that become sensed by the driver through the steering wheel. It can also make for a poor looking wear pattern. Both of these undesired effects often lead to the tire being removed from service at an early stage of its wear life. Generally, the more the tire is put through a slow-wearing usage, the more irregular wear is affecting the removal mileage. This is why resistance to irregular wear is of paramount importance for truck tires in the so-called long haul steer usage.

It is known to include structural features in tires to fight irregular wear. For example, a sacrificial rib can be incorporated into the tread architecture to delay the onset of irregular wear. The sacrificial rib may function by providing a negative tangential force in the contact patch while being decoupled from the shoulder rib but still able to provide some lateral support and increase in lateral rigidity in the shoulder rib. The sacrificial rib may be outboard of the shoulder rib and offset in the radial direction so as to be closer to the central axis of the tire than the shoulder rib. A narrow decoupling groove, usually 1.5 millimeters or less in width, separates the shoulder rib and the sacrificial rib. One drawback to this design is its susceptibility to aggression damage, specifically cracks that can develop at the bottom of the decoupling groove which may lead to early removal and customer dissatisfaction. Attempts have been made to improve the robustness of this decoupling groove to alleviate aggression damage. These modifications include undulations to make the decoupling groove more interlocking, inward curvature at the bottom of the decoupling groove, and the addition of a teardrop at the bottom of the decoupling groove. However, these modifications have been generally unsuccessful in the mitigation of crack initiation and subsequent propagation at and from the bottom of the sacrificial groove. Although mechanisms are known for improving irregular wear, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a heavy truck tire in accordance with the prior art.

FIG. 2 is a cross-sectional perspective view of a prior art heavy truck tire.

FIG. 3 is a cross-sectional perspective view of a heavy truck tire in accordance with one exemplary embodiment.

FIG. 4 is a top view of a portion of the heavy truck tire tread of FIG. 3.

FIG. 5 is a cross-sectional view taken along line 5-5 of FIG. 4.

FIG. 6 is a side view of a portion of the heavy truck tire tread of FIG. 4.

FIG. 7 is a top view of a portion of a heavy truck tire tread in accordance with another exemplary embodiment.

FIG. 8 is a perspective view of a portion of the heavy truck tire tread of FIG. 7.

FIG. 9 is a top view of a portion of a heavy truck tire tread in accordance with another exemplary embodiment.

FIG. 10 is a top view of a portion of a heavy truck tire tread in accordance with another exemplary embodiment.

FIG. 11 is a top view of a portion of a heavy truck tire tread in accordance with another exemplary embodiment.

FIG. 12 is a top view of a portion of a heavy truck tire tread in accordance with another exemplary embodiment.

FIG. 13 is a perspective view of a portion of a heavy truck tire tread in accordance with another exemplary embodiment.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a heavy truck tire 10 tread 12 that includes a shoulder rib 22 and a sacrificial rib 26. The sacrificial rib 26 is decoupled from the shoulder rib 22 not with a decoupling groove, but instead with a series of decoupling sipes 32 that extend circumferentially around the tread 12 and are spaced from one another in the circumferential direction 14. Immediately successive decoupling sipes 32 do not engage one another so that the sacrificial rib 26 touches the shoulder rib 22 at the interface 30.

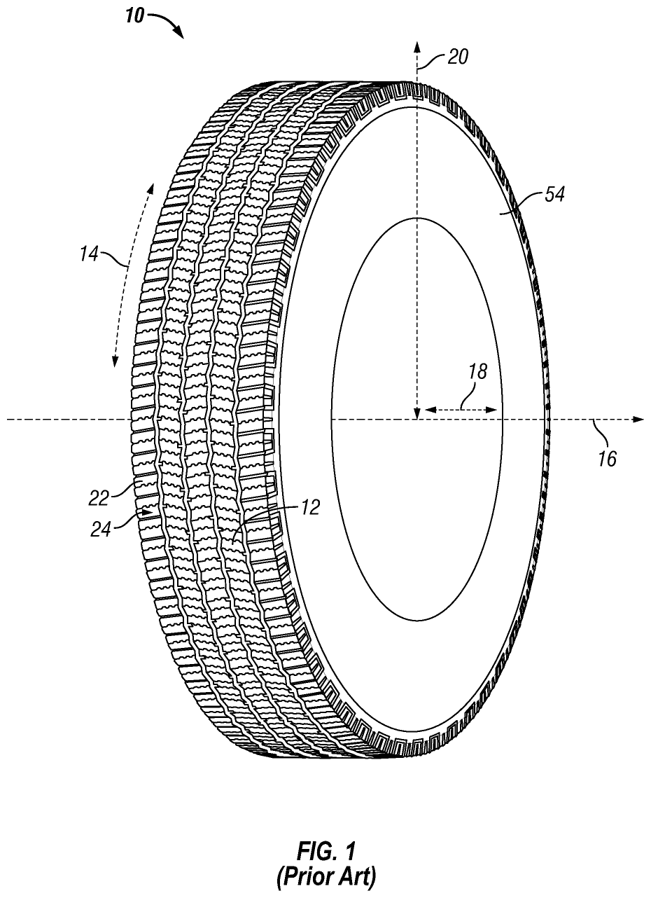

FIG. 1 shows a tire 10 that is a heavy duty truck tire 10. In this regard, the tire 10 is not designed for nor used with a car, motorcycle, or light truck (payload capacity less than 4,000 pounds), but is instead designed for and used with heavy duty trucks such as 18 wheelers, garbage trucks, or box trucks. The tire 10 may be a steer tire, a drive tire, a trailer tire, or an all position tire. The tire 10 can be a free rolling tire on a truck, such as a “pusher” or “tag” axle that is successive of the steer tires on a truck but are free rolling. The tire 10 is not limited to any particular position on the truck or trailer. The tire 10 includes a carcass 54 onto which a tread 12 is disposed thereon. The central axis 16 of the tire 10 extends through the center of the carcass 54, and the lateral direction 18, which can be called the width or axial direction 18, of the tire 10 is parallel to the central axis 16. The radial direction 20 of the tire 10 can be referred to as the thickness direction 20 and is perpendicular to the central axis 16. The tread 12 is located farther from the central axis 16 in the radial direction 20 than the carcass 54. The tread 12 extends all the way around the carcass 54 in the circumferential direction 14 of the tire 10 and circles the central axis 16 three hundred and sixty degrees. The circumferential direction 14 can also be referred to as the longitudinal direction 14 of the tread 12.

The tread 12 features five ribs that are separated by four circumferential grooves that extend in the circumferential direction 14 completely about the tire 10. The five ribs can be classified as a central rib, two intermediate ribs, and two shoulder ribs. Although five ribs are shown any number of ribs can be present in other exemplary embodiments. The ribs can each be made up of a number of tread blocks that can have various shapes, sizes, and configurations. The inclusion of these architectural features gives the tread 12 different performance properties in use. The tire 10 can be a brand new tire with the carcass 54 and tread 12 formed at the same time with both being brand new. Alternatively, the tread 12 may be provided as a retread band that is newly formed and then subsequently attached to an existing, used carcass 54 through a retread process. It is to be understood that the tire 10 illustrated in FIG. 1 does not include a sacrificial rib 26 or decoupling sipes 32 in accordance with the present invention.

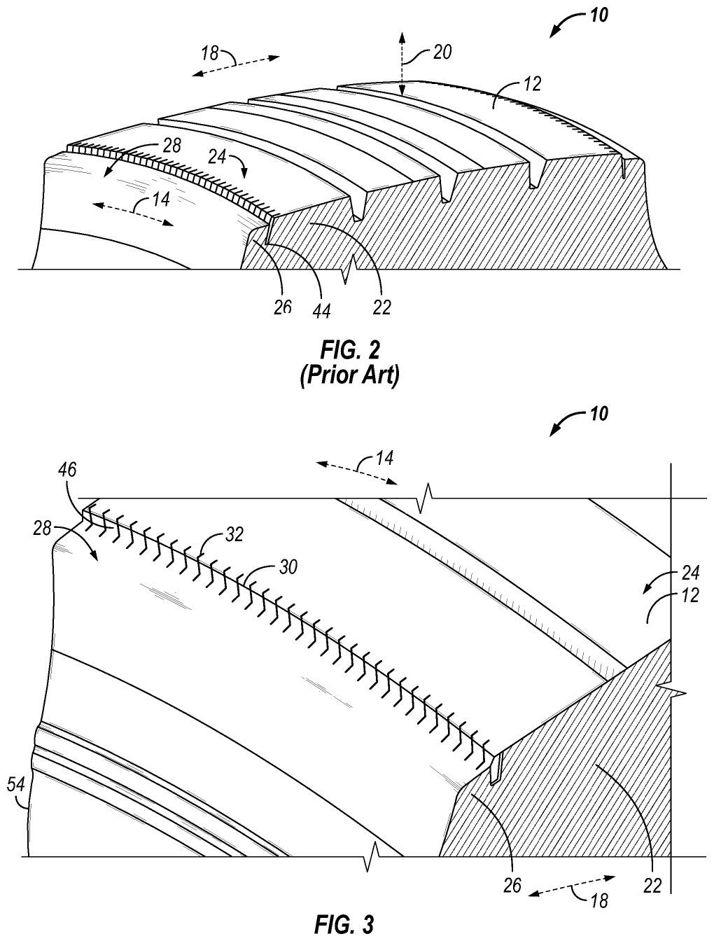

FIG. 2 is a perspective view in cross-section of a prior heavy truck tire 10 tread 12 that includes sacrificial ribs 26 on opposite ends of the tread 12 in the lateral direction 18. The sacrificial rib 26 is positioned immediately outboard from a shoulder rib 22 and is separated therefrom by a decoupling groove 44. The decoupling groove 44 can extend continuously all the way 360 around the tire 10 in the circumferential direction 14 and may have a width that is smaller than the grooves, for example it may have a width of 1.5 millimeters. The decoupling groove 44 extends some amount into the tread 12 and terminates at a point in the radial direction 20 that can be the same position in the radial direction 20 as the circumferential grooves, or more or less into the radial direction 20 than the bottom of the circumferential grooves. The sacrificial rib 26 is stepped down from the shoulder rib 22 such that a sacrificial rib upper surface 28 is closer to the central axis 16 in the radial direction 20 than the shoulder rib upper surface 24 is to the central axis 16 in the radial direction 20. A series of micro sipes are located in the shoulder rib 22 and open into the decoupling groove 44. The shoulder rib upper surface 24 does not abut or engage the sacrificial rib upper surface 28 due to the presence of the decoupling groove 44.

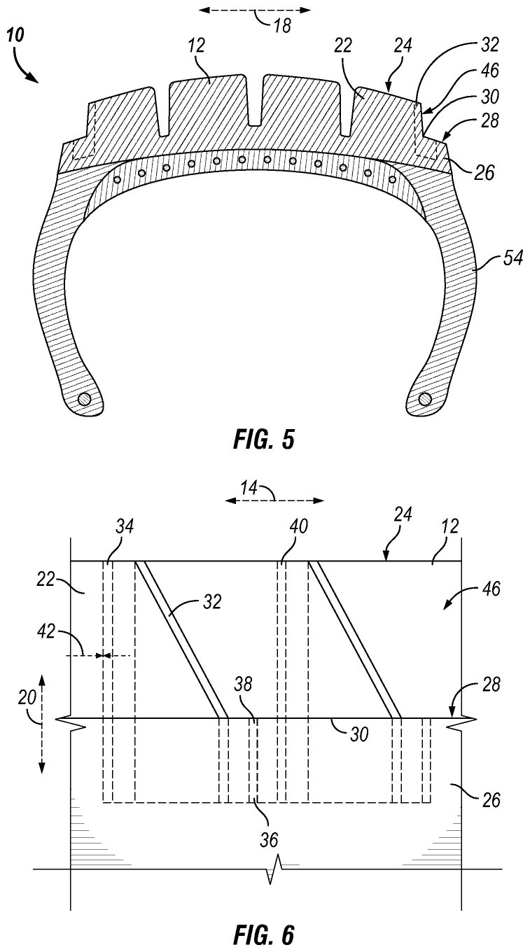

FIGS. 3-6 show one exemplary embodiment of the tread 12. A pair of sacrificial ribs 26 are present and are adjacent two shoulder ribs 22 and are on opposite ends of the tread 12 in the lateral direction 18. The sacrificial ribs 26 are provided to protect the shoulder ribs 22 during use of the tire 10 and will normally wear faster than the shoulder ribs 22 so that the shoulder ribs 22 are not subjected to irregular wear during use. The height of the shoulder ribs 22 in the radial direction 20 is greater than the height of the sacrificial ribs 26 in the radial direction 20. The sacrificial rib upper surface 28 thus steps down from the shoulder rib upper surface 24 such that the sacrificial rib upper surface 28 is located closer to the central axis 16 in the radial direction 20 than the shoulder rib upper surface 24 is located to the central axis 16 in the radial direction 20. A decoupling groove 44 is missing from the tread 12 in that a single continuous groove between the sacrificial rib 26 and the shoulder rib 22 completely around the tire 10 is not present. Instead, a series of decoupling sipes 32 are present completely around the tread 12 in the circumferential direction 14. Immediately successive decoupling sipes 32 do not engage one another, but are instead spaced from and free from engagement with one another. The decoupling sipes 32 can be arranged on the tread 12 so that there is no overlap of any successive decoupling sipes 32 in the circumferential direction 14. In this regard, a portion 38 of one of the decoupling sipes 32 does not share a same position in the circumferential direction 14 as does a portion 40 of an immediately successive decoupling sipe 32 in the circumferential direction 14. In other words, there is no portion of one of the decoupling sipes 32 that is located at the same position in the circumferential direction 12 as any portion of an immediately successive decoupling sipe 32 with respect to that particular shoulder/sacrificial rib 22, 26.

The decoupling sipes 32 are arranged so that they have a component of extension both in the lateral direction 18 and in the circumferential direction 14. The decoupling sipes 32 in the FIGS. 3-6 embodiment thus do not extend only in the lateral direction 18. The decoupling sipes 32 are arranged so that when in the shoulder rib 22 they have a different position in the circumferential direction 14 than they do when they are in the sacrificial rib 26. The decoupling sipes 32 may extend only in the lateral direction 18 along some of their lengths in the shoulder rib 22 and the sacrificial rib 26, but at the interface 30 may extend so as to have components of extension in both the lateral direction 18 and the circumferential direction 14. The widths of the decoupling sipes 32 are consistent along their entire lengths.

With reference now to FIG. 6 in particular, it can be seen that the decoupling sipe 32 has a location 34 in the shoulder rib 22, and a location 36 in the sacrificial rib 26. The location 34 is at a different position in the circumferential direction 14 than the position of location 36 in the circumferential direction 14. Various sections of the decoupling sipe 32 can be located at the same position in the circumferential direction 14. An interface 30 exists between the shoulder rib 22 and the sacrificial rib 26, but a gap is not present and running along this interface 30 continuously in the circumferential direction 14. Instead, the interface 30 is solid at various portions along its entire circumferential length, such that the majority of the interface 30 in the circumferential direction 14 is solid and is not a gap. Disengagement does exist at the interface 30 where the decoupling sipes 32 cross the interface 30 and forms a small gap at these crossings. However, the majority of the length of the interface 30 remains in engagement such that the shoulder rib 22 engages the sacrificial rib 26 between immediately successive decoupling sipes 32. The spaced decoupling sipes 32 function to decouple the sacrificial rib 26 from the shoulder rib 22, and since a continuous decoupling sipe is not present at the interface 30, crack formation and initiation cannot begin and propagate thus minimizing or eliminating aggression damage.

The decoupling sipe 32 can extend into the tread 12 at an angle 42 that is greater than zero degrees. In this regard, the decoupling sipe 32 may extend into the tread 12 so that the decoupling sipe 32 at the outer surface 24, 28 is located at a different position in the circumferential direction 14 than the position of the decoupling sipe 32 farthest into the tread 12 in the radial direction 20. This angle 42 may be from 0-5 degrees, from 5-8 degrees, from 8-10 degrees, from 10-15 degrees, or from and including 8-15 degrees in some embodiments. In a preferred embodiment, angle 42 is 8 degrees. Manufacturing limitations will generally place an upper limit of 15 degrees on angle 42. In the present embodiment, FIG. 6 shows the angle 42 of the decoupling sipe 32 to the radial direction 20 as being zero degrees. As far as extension into the tread 12 in the radial direction 20, the decoupling sipes 32 may extend to the same position in both the shoulder rib 22 and the sacrificial rib 26. In this regard, the decoupling sipe 32 terminates at a common position in the radial direction 20 in the shoulder and sacrificial ribs 22 and 26. Since the shoulder rib 22 is higher than the sacrificial rib 26 in the radial direction 20, the decoupling sipes 32 would in fact cut through more rubber in the shoulder rib 22 than the sacrificial rib 26 when extending through these two ribs 22, 26 to terminate at the common position in the radial direction 20. The entire length of the decoupling sipe 32 in the lateral direction 18 may have a common termination point spaced from the central axis 16 in the radial direction 20.

The tread 12 may be directional in that the tread features are provided so that the tread 12 is designed to roll primarily in one direction. The designed for, forward, direction of roll is known as the rolling direction and can be in any direction in the disclosed embodiments. In FIG. 6, the rolling direction may be to the right in the drawing so that the location 36 is forward of the location 34 in the rolling direction. This will cause the bottom, interior of the decoupling sipe 32 to enter the contact patch before the top, exterior portion of the decoupling sipe 32 that is at the shoulder rib upper surface 24. The tread 12 need not be a directional tread 12 in other instances.

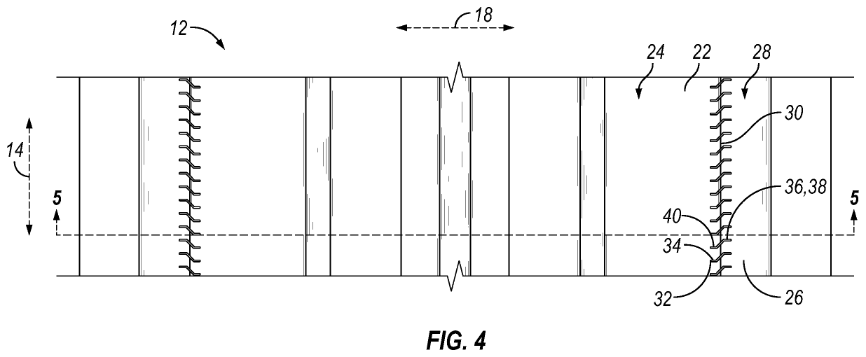

The immediately successive decoupling sipes 32 may have a shape, size and configuration that are identical to one another. With reference now in particular to FIG. 4, they may be spaced from one another in the circumferential direction 14 a distance of 1 millimeter, 2 millimeters, 3 millimeters, from and including 5-7 millimeters, from and including 1-10 millimeters, from and including 4-8 millimeters, from and including 5-6 millimeters, from and including 6-7 millimeters, or from and including 1-3 millimeters in various embodiments. This spacing is consistent along the entire length of the decoupling sipes 32 in the lateral direction 18. As such, for the same location in the lateral direction 18 between two immediately successive decoupling sipes 32, their spacing in the circumferential direction 14 will be the same as compared to any other location in the lateral direction 18 of these two immediately successive decoupling sipes 32. The decoupling sipes 32 are blind such that the decoupling sipes 32 terminate within the shoulder rib 22 and the sacrificial rib 26. The decoupling sipes 32 thus do not engage or open into a center groove, shoulder groove, intermediate groove, or extend around the entire width of the sacrificial rib 26 so as to open on the side of the sacrificial rib 26 in the lateral direction 18.

The length of extension of the decoupling sipes 32 in the lateral direction 18 may be from and including 8-12 millimeters, 6-14 millimeters, 4-16 millimeters, 9-11 millimeters, 5-20 millimeters, or 10 millimeters in accordance with different embodiments. All of the decoupling sipes 32 may extend the same length in the lateral direction 18, or they may be different so that some extend longer amounts than others in the lateral direction 18. The decoupling sipes 32 may be micro sipes. The width of the decoupling sipes 32 is their wall to wall distance. The widths of the decoupling sipes 32 can be the same along their entire lengths or may vary. If varied, the widths of the decoupling sipes 32 can be measured as the width of the majority of the length of the decoupling sipes 32. Acceptable decoupling sipes 32 widths may be from and including 0.1 to 2.0 millimeters. Preferred widths of the decoupling sipes 32 are from and including 0.4 millimeters to 0.6 millimeters. Thinner decoupling sipes 32 are not practical, and decoupling sipes 32 greater than the acceptable range may reduce wear performance of the tread 12. The decoupling sipes 32 could be linear in shape, wavy, angled, curved, non-linear, have sections of differing widths, or may be irregular in shape. A teardrop could be located at the inner portion of the decoupling sipes 32 in the radial direction 20. In the embodiments shown, the bottom of the decoupling sipes 32 do not have a teardrop and are flat or straight in shape.

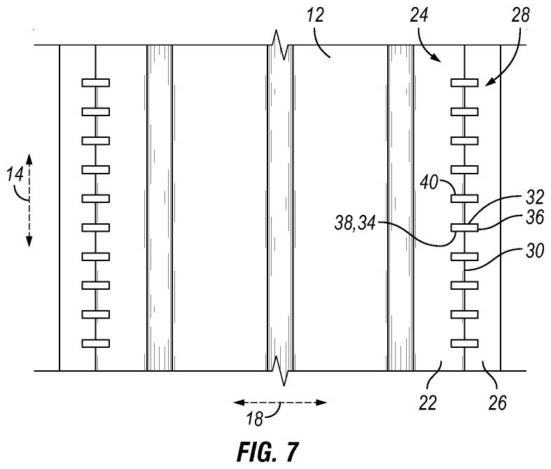

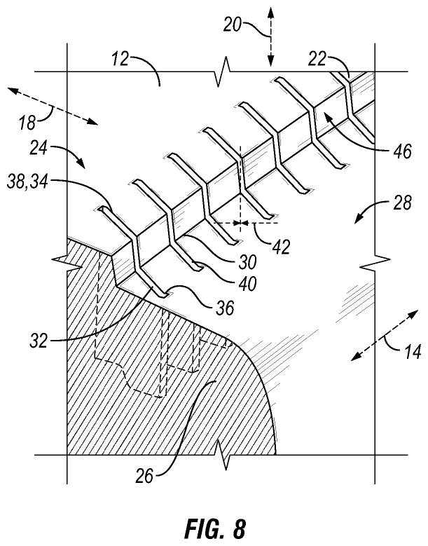

FIGS. 7 and 8 show an alternate embodiment of the tread 12 in which the decoupling sipes 32 extend in a direction that is completely in the lateral direction 18. In this regard, the two locations 34 and 36 as described in the previous embodiments are at the same position in the circumferential direction 14. The decoupling sipes 32 can be positioned such that half of the decoupling sipe 32 is in the shoulder rib 22 and the other half of the decoupling sipe 32 is in the sacrificial rib 26 thus extending through the interface 30. All of the successive decoupling sipes 32 can be spaced the same amount from one another in the circumferential direction 14, and all of the decoupling sipes 32 can be sized, shaped, and configured in an identical manner. The decoupling sipes 32 may extend into the tread 12 so as to reach a single, common depth in the radial direction 20. The lowest position of the decoupling sipe 32 in both the shoulder rib 22 and the sacrificial rib 26 is at a common depth in the radial direction 20 closest to the central axis 16 such that it is consistent along the entire bottom length of the decoupling sipe 32 in the lateral direction 18. The decoupling sipe 32 extends a longer amount through the shoulder rib 22 than though the sacrificial rib 26 because the shoulder rib upper surface 24 is offset in the radial direction 20 from the sacrificial rib upper surface 28. This offset in the radial direction 20 between the shoulder rib upper surface 24 and the sacrificial drib upper surface 28 may be from and including 1.5-3 millimeters, from and including 2-4 millimeters, from and including 1-4 millimeters, from and including 1-3 millimeters, or 2 millimeters in various exemplary embodiments. The decoupling sipes 32 are open at both of the upper surfaces 24 and 28, and are also open at the side surface 46 of the shoulder rib 22. The side surface 46 may extend completely in the radial direction 20 such that a surface normal to the side surface 46 extends completely in the lateral direction 18. The decoupling sipes 32 are again arranged so that immediately successive ones are not in engagement at the interface 30 or at all with one another, as is the case in other embodiments disclosed herein.

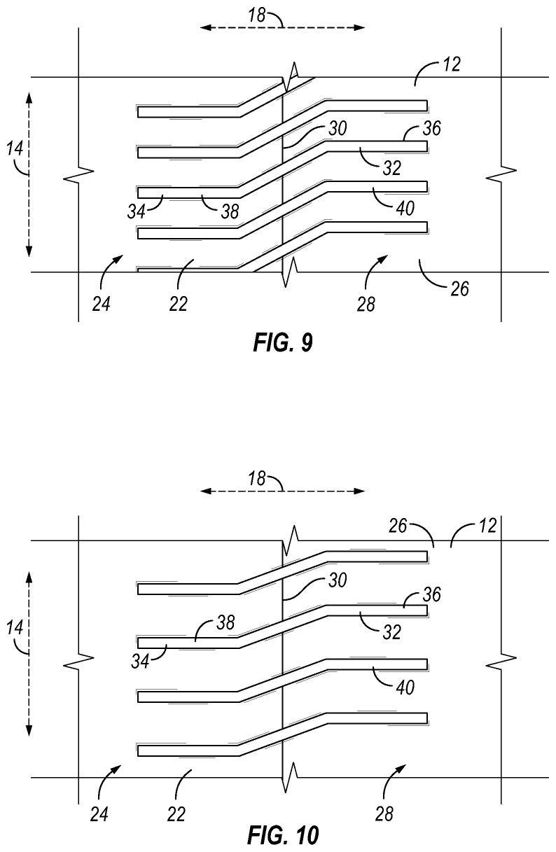

Another exemplary embodiment of the tread 12 is shown with reference to FIG. 9 in which the decoupling sipes 32 are again spaced from one another so as not to be in engagement with one another, and so that the majority of the interface 30 features engagement between the ribs 22, 26 and not a gap between the ribs 22, 26. This embodiment features successive decoupling sipes 32 that have portions 38, 40 that overlap one another in the circumferential direction 14. The decoupling sipe 32 has a portion 38 that is located within the shoulder rib 22, and an immediately successive decoupling sipe 32 has a portion 40 that is located in the sacrificial rib 26. These portions 38 and 40 are both located at the same position in the circumferential direction 14. The decoupling sipes 32 are configured so that they extend completely in the lateral direction 18 in both ribs 22, 26, and then extend in both the circumferential direction 14 and the lateral direction 18 between these two laterally extending sections.

FIG. 10 shows another exemplary embodiment in which the decoupling sipes 32 are similar to those of FIG. 9 in which they have 3 linear extensions with two being only in the lateral direction 18 and the one between these two having components of extension in both the lateral 18 and circumferential 14 directions. However, the portion 38 of one of the decoupling sipes 32 located in the shoulder rib 22 is at a different position in the circumferential direction 14 than is a portion 40 of an immediately successive decoupling sipe 32 that is in the sacrificial rib 26. In fact, there is no portion of the decoupling sipe 32 that shares a common position in the circumferential direction 14 as an immediately successive decoupling sipe 32. In this regard, the decoupling sipe 32 is located completely forward of an immediately successive decoupling sipe 32 in the circumferential direction 14.

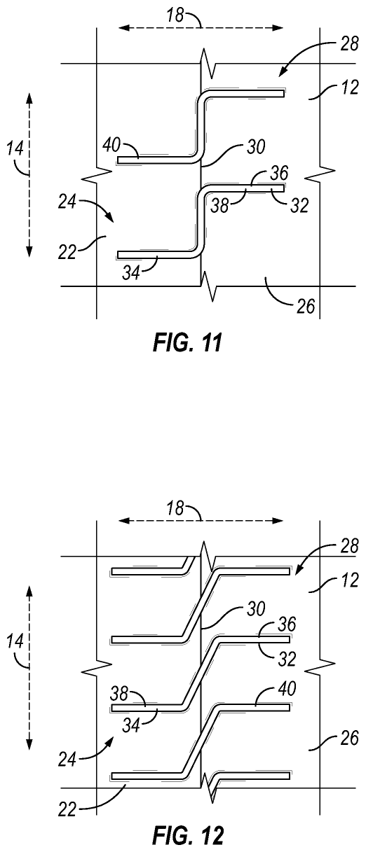

FIG. 11 is an embodiment of the tread 12 in which the decoupling sipes 32 do not overlap in the circumferential direction 14 so that portion 38 of one does not share a common spot in the circumferential direction 14 with a portion 40 of another. This embodiment differs in that the decoupling sipes 32 have a section that extends along the interface 30 so as to have a component of extension in the circumferential direction 14 but not the lateral direction 18. The gap created by the decoupling sipes 32 at the interface 30 may be significant in that more than half of the circumferential length of the interface 30 is a gap and less than half of the circumferential length of the interface 30 features engagement between the shoulder rib 22 and the sacrificial rib 26. The successive decoupling sipes 32 are not in engagement with one another, and include sections that extend completely in the lateral direction 18 in the shoulder and sacrificial ribs 22, 26. Curved portions complete the transition between these sections and the middle, circumferentially extending section.

The embodiment disclosed in FIG. 12 is similar to that as previously discussed with respect to FIG. 9. However, the middle section of the decoupling sipes 32 has a much larger extent in the circumferential direction 14 to result in the decoupling sipe 32 extending a greater length in the circumferential direction 14 than the FIG. 9 embodiment. Again, the portion 38 of one of the decoupling sipes 32 shares a common position in the circumferential direction 14 as a portion 40 of an immediately successive sipe 32. Although the sections of the decoupling sipes 32 are shown as being linear in shape, they can be wavy, curved, or variously shaped in other embodiments. The overall extent of the decoupling sipe 32 may extend for a greater amount in the circumferential direction 14 than in the lateral direction 18. This is contrasted with the decoupling sipes 32 of the FIG. 9 embodiment in which they extended for a longer amount in the lateral direction 18 than in the circumferential direction 14.

In the various embodiments disclosed herein, the decoupling sipes 32 could be straight across and extend only in the lateral direction 18 and not in the circumferential direction 14 so that the locations 34, 36 share the same position in the circumferential direction 14. Other embodiments shown herein have the decoupling sipe 32 extending for some length also in the circumferential direction 14 so that the locations 34, 36 are at different positions in the circumferential direction 14. The amount of extension of the decoupling sipe 32 in the circumferential direction 14 may be from and including 1-3 millimeters, 3-5 millimeters, 5-8 millimeters, 8-10 millimeters, 1-10 millimeters, 3-8 millimeters, and up to 10 millimeters in various embodiments. The greater the extension of the decoupling sipes 32 in the circumferential direction 14, the greater the flexibility of this area of the tread 12. The decoupling sipes 32 have been shown with 1 or 3 sections, but could have any number of sections in other embodiments. As such, it is to be understood that the shapes and configurations of the decoupling sipes 32 disclosed herein are only some examples of that which can be included in the tread 12. The preferred length of the decoupling sipe 32 in the lateral direction 18 is 10 millimeters, but may be from and including 8-12 millimeters in other embodiments. The preferred offset, that is the distance between immediately successive decoupling sipes 32 in the circumferential direction 14, is 2 millimeters but may be from and including 1-3 millimeters in other embodiments. The offset in the circumferential direction 14 may also be described as being the density since it determines the number of decoupling sipes 32 per unit length and will impact the irregular wear performance.

The decoupling sipes 32 may be referred to as micro sipes. These are sipes that terminate within the tread 12 such that they do not extend to a shoulder groove, intermediate groove, center groove, or to an exterior side surface of the tread 12. The micro sipes are short in length in the lateral direction 18 and can have a longer distance in the radial direction 20 than in the lateral direction 18. It is to be understood that the decoupling sipes 32 are not micro sipes in other embodiments.

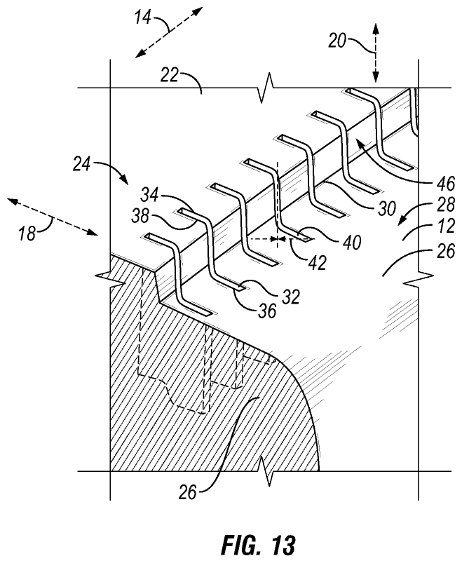

FIG. 13 discloses an embodiment in which the decoupling sipes 32 extend only in the lateral direction 18 and not the circumferential direction 14. The decoupling sipes 32 extend completely in the radial direction 20 such that the angle 42 is zero. However, in other embodiments the decoupling sipes 32 could be oriented at an angle 42 that is not zero. The decoupling sipes 32 do not have a single, common depth in the radial direction 20 and the bottoms of the decoupling sipes 32 have depths that vary at different points of their lengths. The section of the decoupling sipe 32 in the sacrificial rib 26 extends a greater depth into the tread 12 so as to be located closer to the central axis 16 in the radial direction 20 than the section of the decoupling sipe 32 in the shoulder rib 22 is located to the central axis 16 in the radial direction 20. The bottom of the decoupling sipe 32 transitions along the bottom so that the portion of the decoupling sipe 32 below the interface 30 has a varying depth in the radial direction 20. The depths in the radial direction 20 can be set up so that they are equal to one another in that the bottom is the same distance to the upper surface 24 or 28. The step down from the upper surface 24 to the upper surface 28 is translated to the depth of the sipe 32 in the radial direction 20 so that the sipe 32 extends the same amount into the tread 12 but terminates at different positions relative to the central axis 16. It is to be understood that the depth in the radial direction 20 can be varied in different embodiments. For example, in others the depth is greater into the shoulder rib 22 than into the sacrificial rib 26.

The arrangement disclosed thus maintains small rubber bridges intermittently along the length of the interface 30 such that a continuous decoupling groove between the shoulder and sacrificial ribs 22, 26 does not exist. In the preferred embodiment the decoupling sipes 32 are wavy such as those disclosed herein in which parts are located as different positions in the circumferential direction 14. Applicant has discovered that incorporating decoupling sipes 32 that extends in both the circumferential and radial directions 14, 20 maintains adequate decoupling between the shoulder rib 22 and the sacrificial rib 26. The decoupling sipes 32 can be formed in the tread 12 in the manufacturing process by using 3D metal printing techniques. The plurality of decoupling sipes 32 can be included on the shoulder ribs 22 and sacrificial ribs 26 on both lateral sides of the tread 12, or could be present on only one of the shoulder/sacrificial ribs 22, 26. Further, the tread 12 may be provided as part of a round heavy truck tire 10 with a new carcass 54, or the tread 12 could be a retread band that is attached to a previously used carcass 54 to extend the life of the tire 10.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A tread for a heavy truck tire, comprising:
a circumferential direction that extends about a central axis, a lateral direction that extends parallel to the central axis, and a radial direction that is perpendicular to the central axis;
a shoulder rib having a shoulder rib upper surface;
a sacrificial rib having a sacrificial rib upper surface, wherein the sacrificial rib is located outboard from the shoulder rib in the lateral direction and engages the shoulder rib such that an interface is present at engagement of the sacrificial rib and the shoulder rib, wherein the sacrificial rib upper surface is located closer to the central axis in the radial direction than the shoulder rib upper surface is located to the central axis in the radial direction; and
a plurality of decoupling sipes in the shoulder rib that extend through the interface and into the sacrificial rib, wherein the decoupling sipes are spaced from one another in the circumferential direction such that immediately successive ones of the decoupling sipes are not in engagement at the interface, wherein the sacrificial rib engages the shoulder rib at the interface between immediately successive ones of the decoupling sipes, wherein a decoupling groove between the shoulder rib and the sacrificial rib is not present.

2. The tread as set forth in claim 1, wherein the sacrificial rib engages the shoulder rib continuously along the interface between immediately successive ones of the decoupling sipes.

3. The tread as set forth in claim 1, wherein each one of the decoupling sipes has a location in the shoulder rib and a location in the sacrificial rib, wherein the location in the shoulder rib has a different position in the circumferential direction than the location in the sacrificial rib.

4. The tread as set forth in claim 3, wherein each one of the decoupling sipes extends through some of the shoulder rib in a direction that is completely oriented in the lateral direction, and wherein each one of the decoupling sipes extends through some of the sacrificial rib in a direction that is completely oriented in the lateral direction.

5. The tread as set forth in claim 1, wherein immediately successive ones of the decoupling sipes are spaced from one another in the circumferential direction such that immediately successive ones of the decoupling sipes do not share a same position in the circumferential direction.

6. The tread as set forth in claim 1, wherein immediately successive ones of the decoupling sipes are spaced from one another in the circumferential direction such that immediately successive ones of the decoupling sipes have portions that share a same position in the circumferential direction.

7. The tread as set forth in claim 1, wherein the decoupling sipes extend from the shoulder rib upper surface and the sacrificial rib upper surface into the shoulder rib and the sacrificial rib at an angle greater than zero degrees to the radial direction.

8. The tread as set forth in claim 7, wherein the angle is from and including 8 degrees to 15 degrees.

9. The tread as set forth in claim 1, wherein immediately successive ones of the decoupling sipes are spaced from one another in the circumferential direction a distance that is from and including 5 millimeters to 7 millimeters at all positions of the decoupling sipes in the lateral direction.

10. The tread as set forth in claim 1, wherein the decoupling sipes are blind such that the decoupling sipes terminate within the shoulder rib in the lateral direction and terminate within the sacrificial rib in the lateral direction.

11. The tread as set forth in claim 1, wherein the decoupling sipes extend into the shoulder rib and the sacrificial rib to terminate at a common position in the radial direction in the shoulder rib and the sacrificial rib.

12. The tread as set forth in claim 1, wherein the decoupling sipes have a width that is from and including 0.4 millimeters to 0.6 millimeters, and wherein the decoupling sipes extend in the lateral direction an amount that is from and including 8 millimeters to 12 millimeters.

13. The tread as set forth in claim 1, wherein the tread is a retread band.

14. A heavy truck tire that has the heavy truck tire tread of claim 1.
